(19) United States
(12) Patent Application Publication
(10) Pub. No.: US 2026/0347274 A1
(43) Pub. Date: Nov. 5, 2026

(54) FISH HYDROLYSATE COMPOSITION AND METHODS OF PREPARING THE SAME

(71) Applicant: Biocore Agri Ltd., Lancashire (GB)

(72) Inventor: Stephen Lee Welsh, Thornton-Cleveleys (GB)

(21) Appl. No.: 19/130,627

(22) PCT Filed: Nov. 14, 2023
(86) PCT No.: PCT/GB2023/052970

§ 371 Date: May 16, 2025

(30) Foreign Application Priority Data
Nov. 17, 2022 (GB) 2217212.6

(51) Int. Cl. C05F 1/00; A23K 10/12; A23K 10/14; A23K 30/00; A23K 50/10

(52) U.S. Cl. CPC C05F 1/002; A23K 10/12; A23K 10/14; A23K 30/00; A23K 50/10

(57) ABSTRACT

The present invention relates to a method of preparing a fish hydrolysate composition and a fish hydrolysate composition obtained by the same. The present invention also relates to an animal feed, fertiliser or soil enhancer comprising the fish hydrolysate composition of the present invention.

### FIELD OF THE INVENTION

The present invention relates to a method of preparing a fish hydrolysate composition and a fish hydrolysate composition obtained by the same. The present invention also relates to an animal feed, fertiliser or soil enhancer comprising the fish hydrolysate composition of the present invention.

### BACKGROUND OF THE INVENTION

Recent studies have predicted that the world's population is expected to increase to 8.5 billion by 2030 and a further 9.7 billion people by 2050. Consequently, meat consumption is also predicted to continue growing due to this increase in the world's population and the resulting global economic expansion. Research indicates that as personal wealth and household incomes grow in developing economies, so will meat consumption per capita in these countries. Meat consumption in developed countries will also remain high at the same time. This has downstream consequences on the global demand for animal protein and it is speculated that agricultural greenhouse gas (GHG) emissions worldwide could rise 58% by 2050.

The concentration of one such greenhouse gas, atmospheric methane, continues to rise, with the mole fraction of methane reaching its highest in four decades in 2020 with a 14.7 parts per billion (ppb) average global increase. Relatively, methane has been rising two times as fast as carbon dioxide since 1750 and is now two and half times greater than in pre-industrial levels. Agriculture plays a large role in methane levels rising. Agriculture-related sources (e.g. farmed ruminants) in 2017 contributed approximately two-thirds of global anthropogenic methane emissions with fossil fuels making up the rest. Agricultural activities also dominate the anthropogenic emissions of nitrous oxide.

Ruminants contribute between 16-25% to global greenhouse gas emissions and dairy farms have been known to have up to 1000 times the average methane concentration. Equally nitrous oxide also has a high potency 300 times that of CO₂ on a 100-year timescale.

Recent reports acknowledge that dietary supplements (e.g. animal feed additives) such as essential oils and red algae can reduce methane emissions from ruminants but do so, sometimes, at the expense of feed digestion and fermentation efficiency. In addition, as these dietary supplements are often additional to a farmer's variable cost, there is an economic barrier to the uptake of methane-reducing animal feed technology. This is accentuated when considering that national laws do not require agricultural sectors to reduce methane output. It therefore follows that reducing GHG emissions from ruminant animals (and the wider agricultural sector) in the form of methane and nitrous oxide reduction remains a challenge.

Whilst methane reducing compositions for use in ruminant animal feeds are already known, for example, certain species of red marine macroalgae such as Asparagopsis A Taxiformis, many of these suffer from processing issues and are therefore not ideal for use in animal fees in larger amounts or for frequent use.

It is a further object of the invention to obviate or mitigate at one or more of the disadvantages of the prior art whether described herein or elsewhere.

### SUMMARY OF THE INVENTION

The present invention relates to a method of preparing a fish hydrolysate composition using fish input. The inventors have established that the fish hydrolysate compositions of the present invention possess unexpected and surprising methane reduction properties when used in animal feed products. Without being bound by theory, this reduction in methane production in animals (e.g. ruminant animals) occurs via a variety of modes. These include reducing methanogenic processes in the animal's digestive cycle, limiting/preventing enzymes involved in methanogenesis or by reducing/destroying methanogenic microorganisms present in the animal's gastrointestinal tract. It has also been observed by the present inventors that the fish hydrolysate compositions of the present invention have, in addition to their beneficial use in animal feed applications, excellent effects when incorporated into fertilisers and soil enhancers within the agricultural and horticultural sectors.

In a first aspect of the present invention there is provided a method of preparing a fish hydrolysate composition, comprising:
providing a fish input;
performing a step of intrinsic enzymatic degradation, in the absence of an additive enzyme, to provide a hydrolysate intermediate; and
fermenting the hydrolysate intermediate in the presence of a lactic acid producing bacterial culture media to produce the fish hydrolysate composition.

In a second aspect of the present invention there is provided a fish hydrolysate composition obtained according to a method of the first aspect of the present invention or any embodiment thereof.

In a third aspect of the present invention there is provided an animal feed comprising the fish hydrolysate composition obtained according to a method of the first aspect of the present invention or any embodiment thereof or the fish hydrolysate composition according to the second aspect of the present invention or any embodiment thereof.

In a fourth aspect of the present invention there is a fertiliser or soil enhancer comprising the fish hydrolysate composition obtained according to a method of the first aspect of the present invention or any embodiment thereof or the fish hydrolysate composition according to the second aspect of the present invention or any embodiment thereof.

In a fifth aspect of the present invention there is a method of reducing methane and/or increasing metabolic efficiency in an animal comprising administering the fish hydrolysate composition obtained according to a method of the first aspect of the present invention or any embodiment thereof or the fish hydrolysate composition according to the second aspect of the present invention or any embodiment thereof or animal feed according to the second aspect of the present invention or any embodiment thereof to an animal; optionally wherein the animal is a ruminant animal.

In a sixth aspect of the present invention there is a composition for use in a method of reducing methane and/or increasing metabolic efficiency in an animal comprising administering the fish hydrolysate composition obtained according to a method of the first aspect of the present invention or any embodiment thereof or the fish hydrolysate composition according to the second aspect of the present invention or any embodiment thereof or animal feed according to the second aspect of the present invention or any embodiment thereof to an animal; optionally wherein the animal is a ruminant animal.

In seventh aspect of the present invention there is a use of the fish hydrolysate composition obtained according to a method of the first aspect of the present invention or any embodiment thereof, the fish hydrolysate composition according to the second aspect of the present invention or any embodiment thereof, or the fertiliser or soil enhancer of the fourth aspect of the present invention or any embodiment of for horticulture or agriculture.

As used herein, a “fish input” refers to any fish based starting material. It will be appreciated that terms fish input and fish input material may be used interchangeable herein. Fish input may include whole fish or by-products thereof. In embodiments, the fish input comprises whole fish, fish meat, fish offal, fish guts, fish bones, fish cartilage, fish scales or any combination thereof. In some embodiments, the fish input is whole fish. It will be appreciated that the fish input may include input material obtained from any suitable fish species. In some embodiments, the fish input includes material obtained from Blue Whiting, Sprat, Herring, Mackeral, Horse Mackerel, Cod, Bass, Plaice, Turbot, Brill, Pollack, Bream, Sole, Halibut, Flounder, DAB, Coalfish, Garfish, Pelagic, Demersal or any combination thereof. In further embodiments, the fish input is whole fish and of the Blue Whiting species. The fish input may also be a freshwater fish species.

It will be appreciated that the fish input may be provided in any suitable form that is capable of undergoing intrinsic enzymatic degradation as described herein. The fish input, in some embodiments, is in the form of a liquid, solid, slurry or any mixture thereof. The fish input may be in dry form, suspended in an aqueous medium or formed as a frozen block. The fish input may, in some embodiments, include material that is not frozen at optionally at room temperature. It will be understood that the fish input may optionally be subjected to maceration, as described herein, before undergoing intrinsic enzymatic degradation.

In some embodiments, the fish input is in the form of a frozen block, wherein the frozen block has a weight of from about 1 kilogram to about 100 kilograms per block, from about 1 kilogram to about 50 kilograms per block, from about 1 kilogram to about 25 kilograms per block, from about 50 kilogram to about 100 kilograms per block, from about 75 kilogram to about 100 kilograms per block or from about 10 kilogram to about 30 kilograms per block. In embodiments, the fish input is in the form of a frozen block, wherein the frozen block has a weight of from about 15 kilogram to about 20 kilograms per block. In embodiments, the fish input comprises a frozen block having a weight of from about 15 kilogram to about 20 kilograms per block and wherein the fish input material is obtained from Blue Whiting (e.g. is whole fish of the Blue Whiting species).

The method of preparing a fish hydrolysate according to the present invention includes performing a step of intrinsic enzymatic degradation, in the absence of an additive enzyme, to provide a hydrolysate intermediate. It will be appreciated that the step of intrinsic enzymatic degradation refers to the enzymatic cleavage of the fish input material (i.e. cleavage of molecular bonds within the fish input material) by enzymes that are native to the initial fish input material. In other words, the step of intrinsic enzymatic degradation involves the use of enzymes that are found naturally in the fish input material without the addition of additive enzymes. This includes, at least, natural enzymes that originally reside in the gastrointestinal tract of the particular fish species used on which the fish input material is based. During this step of intrinsic enzymatic degradation, additive enzymes are absent. That is, enzymes that are not naturally found in the initial fish input material are not present or added during the step of intrinsic enzymatic degradation. The present inventors have found that by subjecting the fish input to the moderate intrinsic enzymatic degradation using only intrinsic enzymes prior to, or as an alternative to, additive enzymatic degradation, a superior final fish hydrolysate composition is produced with enhanced methane reduction properties. This is supported by the methane reduction tests described herein.

In some embodiments, the step of intrinsic enzymatic degradation is performed within an aqueous environment. In such embodiments, the presence of water is required to form the aqueous environment. The water in the aqueous environment during the step of intrinsic enzymatic degradation facilitates enzymatic digestion of the fish input material via hydrolytic cleavage of molecular bonds found within the fish input material. It will be appreciated that the water may be brought into contact with the fish input material (added to the fish input or visa versa) during the step of intrinsic enzymatic degradation or the water may already form part of the fish input material before being subjected to the step of intrinsic enzymatic degradation (e.g. the fish input already includes a high water content). Where the step of intrinsic enzymatic degradation is performed within an aqueous environment, the weight to weight ratio (w/w ratio) of fish input material to water is from about 1:1 to about 1:5. Preferably, the weight to weight ratio (w/w ratio) of fish input material to water is from about 1:2 to about 1:4 or the weight to weight ratio (w/w ratio) of fish input material to water is 1:2.

In some embodiments, the step of intrinsic enzymatic degradation comprises adding frozen fish input material (e.g. frozen blocks of fish input which have optionally undergone maceration) to a pre-heated water bath which is held at a temperature of from about 60 °C to about 70 °C. As the frozen blocks thaw this creates the aqueous environment in which the intrinsic enzymatic degradation is performed. The pre-heated water allows for the target intrinsic enzymatic degradation temperature (e.g. from about 30 °C to about 50 °C) to be reached more rapidly as the fish input thawing process is enhanced.

In some embodiments, the step of intrinsic enzymatic degradation is performed at a temperature of from about 30 °C to about 50 °C, optionally wherein the step of intrinsic enzymatic degradation is performed for a duration of from about 0.5 hours to about 5 hours.

The step of intrinsic enzymatic degradation may be performed at a temperature of from about 30 °C to about 50 °C, from about 35 °C to about 50 °C, from about 40 °C to about 50 °C, from about 45 °C to about 50 °C, from about 30 °C to about 45 °C, from about 30 °C to about 40 °C or from about 30 °C to about 35 °C. Preferably, the step of intrinsic enzymatic degradation may be performed at a temperature of approximately 35 °C, approximately 37 °C or approximately 40 °C.

In other embodiments, the step of intrinsic enzymatic degradation is performed for a duration of from about 0.5 hours to about 5 hours, from about 1 hours to about 5 hours, from about 2 hours to about 5 hours, from about 3 hours to about 5 hours, from about 4 hours to about 5 hours, from about 0.5 hours to about 4 hours, from about 0.5 hours to about 3 hours, from about 0.5 hours to about 2 hours, from about 0.5 hours to about 1 hours, from about 1 hours to about 4 hours or from about 2 hours to about 3 hours. The step of intrinsic enzymatic degradation is performed, in embodiments, for a duration of approximately 2 hours, approximately 2.5 hours or approximately 3 hours.

In further embodiments, the step of intrinsic enzymatic degradation is performed at a temperature of from about 30 °C to about 50 °C for a duration of from about 0.5 hours to about 5 hours. In other embodiments, the step of intrinsic enzymatic degradation is performed at a temperature of from about 30 °C to about 40 °C for a duration of from about 2 hours to about 3 hours.

During the step of intrinsic enzymatic degradation, the fish input material may be agitated or circulated (when suspended in or forming an aqueous environment) so as to ensure that any solid/particulate matter/sediment is mobilised. Agitation or circulation also prevents the stratification of fish input material which can be detrimental to enzymatic degradation.

It will be appreciated that the step of intrinsic enzymatic degradation includes at least one intrinsic enzyme that is native to the initial fish input material and is found in the fish input material naturally. For example, where the fish input is a material based on Blue Whiting, the step of intrinsic enzymatic degradation includes at least one intrinsic enzyme that is native to the Blue Whiting species (e.g. at least one intrinsic enzyme which resides in the gastrointestinal system of a Blue Whiting fish).

In some embodiments, the step of intrinsic enzymatic degradation comprises degradation by at least one intrinsic enzyme comprising a proteolytic enzyme, carbohydrase enzyme, lipolytic enzyme, phosphatase enzyme, transaminases, amino acid decarboxylases, glutamic dehydrogenases or any combination thereof. In some embodiments, the proteases comprise at least one cathepsin. The proteolytic enzyme may comprise at least one peptidase.

The proteolytic enzyme may be selected from the group consisting of a trypsin, carboxypeptidase A and carboxypeptidase B or any combination thereof. The carbohydrase enzyme may be selected from the group consisting of a maltase, amylase or any combination thereof. The lipolytic enzyme may be a lipase. The phosphatase enzyme may be an alkaline phosphatase.

In embodiments, the step of intrinsic enzymatic degradation is followed by the addition of an additive proteolytic enzyme and then proteolytic degradation until a pH of 6 or less is reached to provide a hydrolysate intermediate.

It will be appreciated that the additive proteolytic enzyme is added after the step of intrinsic enzymatic degradation is performed so as to ensure that the fish input material is subjected to a more gentle intrinsic enzymatic degradation before proteolytic enzymatic degradation is then performed in the presence of the additive proteolytic enzyme. In embodiments, there may be an optional step of pasteurisation between the step of intrinsic enzymatic degradation and additional of the additive proteolytic enzyme. Typically, this optional step of pasteurisation is performed at 65 °C to 75 °C for approximately 3 hours so as to destroy or denature the intrinsic enzymes.

The proteolytic degradation is performed until a pH of 6 or less is reached to provide a hydrolysate intermediate. In embodiments, proteolytic degradation is performed until a pH of 5.5 or less, 5 or less, 4.5 or less, 4 or less, 3.5 or less, or 3 or less is reached. Typically, proteolytic degradation is performed until a pH of from about 4 to about 6 or a pH of approximately 5.5 is reached to provide a hydrolysate intermediate.

In embodiments, the proteolytic degradation in the presence of an additive proteolytic enzyme is performed for any suitable period of time until the desired pH is reached. The proteolytic degradation in the presence of an additive proteolytic enzyme may be performed for a period of time from about 1 hour to about 12 hours, from about 2 hours to about 12 hours, from about 3 hours to about 12 hours, from about 4 hours to about 12 hours, from about 5 hours to about 12 hours, from about 6 hours to about 12 hours, from about 1 hour to about 11 hours, from about 1 hour to about 10 hours, from about 1 hour to about 9 hours, from about 1 hour to about 8 hours, from about 1 hour to about 7 hours or from about 1 hour to about 6 hours.

In some embodiments, the step of the proteolytic degradation in the presence of an additive proteolytic enzyme is performed at a temperature of from about 30 °C to about 50 °C, optionally wherein the step of the proteolytic degradation in the presence of an additive proteolytic enzyme is performed for a duration of from about 1 hour to about 12 hours.

The step of proteolytic degradation in the presence of an additive proteolytic enzyme may be performed at a temperature of from about 30 °C to about 50 °C, from about 35 °C to about 50 °C, from about 40 °C to about 50 °C, from about 45 °C to about 50 °C, from about 30 °C to about 45 °C, from about 30 °C to about 40 °C or from about 30 °C to about 35 °C. Preferably, the step of proteolytic degradation in the presence of an additive proteolytic enzyme may be performed at a temperature of approximately 35 °C, approximately 37 °C or approximately 40 °C.

In some embodiments, the step of proteolytic degradation in the presence of an additive proteolytic enzyme is performed at a temperature of from about 30 °C to about 50 °C for a duration of from about 1 hour to about 12 hours. In other embodiments, the step of proteolytic degradation in the presence of an additive proteolytic enzyme is performed at a temperature of from about 30 °C to about 40 °C for a duration of from about 2 hours to about 10 hours.

During the step of proteolytic degradation in the presence of an additive proteolytic enzyme, the fish input material may be agitated or circulated (when suspended in or forming an aqueous environment) so as to ensure that solid/particulate matter and sediment are mobilised. Agitation or circulation also prevents the stratification of material which can be detrimental to enzymatic degradation and also ensure through mixing of the additive proteolytic enzyme through the fish input material.

During the step of proteolytic degradation in the presence of an additive proteolytic enzyme, the additive proteolytic enzyme is added in an amount of from about 0.01 wt % (by weight of the fish input) to about 1 wt % (by weight of the fish input). For example, if 100 kilograms of fish input material (e.g. 100 kilograms of frozen blocks of Blue Whiting) is used (as depicted in step (1) in FIG. 1) and the amount of additive proteolytic enzyme to be used is 0.03 wt % (by weight of the fish input), then 0.03 kilograms (30 grams) of the additive proteolytic enzyme is utilised. In other embodiments, the additive proteolytic enzyme is added in an amount of from about 0.01 wt % (by weight of the fish input) to about 0.5 wt % (by weight of the fish input), from about 0.01 wt % (by weight of the fish input) to about 0.25 wt % (by weight of the fish input), from about 0.01 wt % (by weight of the fish input) to about 0.1 wt % (by weight of the fish input), from about 0.01 wt % (by weight of the fish input) to about 0.05 wt % (by weight of the fish input) or from about 0.02 wt % (by weight of the fish input) to about 0.04 wt % (by weight of the fish input). Preferably, the additive proteolytic enzyme is added in an amount of approximately 0.03 wt % (by weight of the fish input).

The method of preparing a fish hydrolysate according to the present invention includes fermenting the hydrolysate intermediate in the presence of a lactic acid producing bacterial culture media to produce the fish hydrolysate composition. It will be appreciated that the hydrolysate intermediate may have optionally undergone a first pasteurisation step (as described herein) in to order to destroy or denature the enzymes present within the fish input material during the steps of intrinsic enzymatic degradation and proteolytic degradation in the presence of an additive proteolytic enzyme.

It will be appreciated that the step of fermenting the hydrolysate intermediate in the presence of a lactic acid producing bacterial culture media involves the further degradation of the hydrolysate intermediate material by enzymes which are produced by bacteria in the lactic acid producing bacterial culture media. This fermenting step is necessarily carried out under conditions which allow for bacteria to remain viable and active. The lactic acid producing bacterial culture media includes at least one bacteria species that produces lactic acid (i.e. at least one lactic acid bacteria) and may optionally include a sugar component. In embodiments, the lactic acid producing bacterial culture media includes at least one bacteria species that produces lactic acid (i.e. at least one lactic acid bacteria), at least one bacteria species that produces acetic acid (i.e. at least one acetic acid bacteria) and may optionally include a sugar component.

As referred to herein the lactic acid bacteria may be selected from the genus groups consisting of Lactobacillus, Leuconostoc, Pediococcus, Lactococcus, Streptococcus, Aerococcus, Carnobacterium, Enterococcus, Oenococcus, Sporolactobacillus, Tetragenococcus, Vagococcus, Weissella or any combination thereof. In embodiments, the lactic acid bacteria may comprise at least one species from the Lactobacillus genus and/or Pediococcus genus.

In further embodiments, the lactic acid producing bacterial culture media comprises at least one species from the Lactobacillus genus and optionally a sugar component. In other embodiments, the lactic acid producing bacterial culture media comprises at least one species from the Lactobacillus genus and/or Pediococcus genus and optionally a sugar component. The bacterial culture media may, in embodiments, comprises Lactobacillus plantarum, Pediococcus pentosaceus and Lactobacillus brevis. In such embodiments, bacterial culture media optionally includes a sugar component.

In some embodiments, the lactic acid producing bacterial culture media comprises at least one homo-fermentive bacteria strain and/or at least one hetero-fermentive bacteria strain.

As referred to herein “sugar component” includes any suitable sugar containing material or sugar source which is consumed by at least one bacteria species present in the lactic acid producing bacterial culture media during the step of fermenting the hydrolysate intermediate. In preferred embodiments, the sugar component comprises molasses.

In embodiments, the sugar component is used in an amount of from about 5 wt % (by weight of the fish input) to about 50 wt % (by weight of the fish input), from about 10 wt % (by weight of the fish input) to about 50 wt % (by weight of the fish input), from about 20 wt % (by weight of the fish input) to about 50 wt % (by weight of the fish input), from about 30 wt % (by weight of the fish input) to about 50 wt % (by weight of the fish input), from about 40 wt % (by weight of the fish input) to about 50 wt % (by weight of the fish input), from about 5 wt % (by weight of the fish input) to about 40 wt % (by weight of the fish input), 5 wt % (by weight of the fish input) to about 30 wt % (by weight of the fish input), 5 wt % (by weight of the fish input) to about 20 wt % (by weight of the fish input), 5 wt % (by weight of the fish input) to about 10 wt % (by weight of the fish input), 10 wt % (by weight of the fish input) to about 40 wt % (by weight of the fish input) or 20 wt % (by weight of the fish input) to about 40 wt % (by weight of the fish input). In further embodiments, the sugar component is used in an amount of from about 25 wt % (by weight of the fish input) to about 50 wt % (by weight of the fish input). Typically, the sugar component is used in an amount of approximately 30 wt % (by weight of the fish input). In such embodiments, the sugar component comprises molasses.

In some embodiments, there is a step of fermenting the hydrolysate intermediate in the presence of a lactic acid producing bacterial culture media to produce the fish hydrolysate composition wherein the lactic acid producing bacterial culture media comprises Lactobacillus plantarum, Pediococcus pentosaceus and Lactobacillus brevis, and molasses in an amount of approximately 30 wt % (by weight of the fish input).

Fermenting the hydrolysate intermediate in the presence of a lactic acid producing bacterial culture media to produce the fish hydrolysate composition may be performed at a temperature of from about 30 °C to about 50 °C; optionally wherein fermenting the hydrolysate intermediate in the presence of a lactic acid producing bacterial culture media to produce the fish hydrolysate composition may be performed for a duration of from about 120 hours to about 240 hours.

In embodiments, the fermenting the hydrolysate intermediate in the presence of a lactic acid producing bacterial culture media to produce the fish hydrolysate composition is performed at a temperature of from about 30 °C to about 50 °C, from about 35 °C to about 50 °C, from about 40 °C to about 50 °C, from about 45 °C to about 50 °C, from about 30 °C to about 45 °C, from about 30 °C to about 40 °C or from about 30 °C to about 35 °C. Preferably, the fermenting the hydrolysate intermediate in the presence of a lactic acid producing bacterial culture media to produce the fish hydrolysate composition is performed at a temperature of approximately 35 °C, approximately 37 °C or approximately 40 °C.

In some embodiments, fermenting the hydrolysate intermediate in the presence of a lactic acid producing bacterial culture media to produce the fish hydrolysate composition may be performed for a duration of from about 120 hours to about 240 hours, from about 24 hours to about 240 hours, from about 48 hours to about 240 hours, from about 60 hours to about 240 hours, from about 72 hours to about 240 hours, from about 84 hours to about 240 hours, from about 96 hours to about 240 hours, from about 108 hours to about 240 hours, from about 132 hours to about 240 hours, from about 144 hours to about 240 hours, from about 156 hours to about 240 hours, from about 168 hours to about 240 hours, from about 180 hours to about 240 hours, from about 192 hours to about 240 hours, from about 204 hours to about 240 hours, from about 216 hours to about 240 hours, from about 228 hours to about 240 hours, from about 120 hours to about 228 hours, from about 120 hours to about 216 hours, from about 120 hours to about 204 hours, from about 120 hours to about 192 hours, from about 120 hours to about 180 hours, from about 120 hours to about 168 hours, from about 120 hours to about 156 hours, from about 120 hours to about 144 hours or from about 120 hours to about 132 hours.

In further embodiments, fermenting the hydrolysate intermediate in the presence of a lactic acid producing bacterial culture media to produce the fish hydrolysate composition is performed until a pH of 4 or less is reached. In embodiments, fermenting the hydrolysate intermediate in the presence of a lactic acid producing bacterial culture media to produce the fish hydrolysate composition is performed until a pH of 2 or less, 3 or less, 5 or less or 6 or less is reached. It will be appreciated that, in some embodiments, the pH of the fish input material during the step of fermenting decreases due to the generation of lactic acid and/or acetic acid during fermentation. This occurs without the need for an additive or external source of acid being introduced into the fish input material.

It will be appreciated that the fish input may undergo a step of maceration before undergoing the step of intrinsic enzymatic degradation; optionally wherein the step of maceration may provide a particle size within the fish input of from about 2 mm to about 6 mm. One such technique of macerating fish input known to the skilled person requires passing fish input material through a hydraulic macerator whereby the particle size within the fish input can be controlled by selecting an appropriately sized screening die plate through which macerated fish input material is passed. The screening die plate contains a plurality of openings/perforations of a certain size which controls the particle size within the fish input during/after maceration. In some embodiments, the step of maceration before undergoing the step of intrinsic enzymatic degradation is industrial grinding, shredding and/or flaking of the fish input material using techniques known to the skilled person in the art.

It will be appreciated that the macerated fish input material may be in the form of a solid, liquid, suspension or slurry. Where the fish input material after maceration is at a temperature lower than the target temperature required for the step of intrinsic enzymatic degradation (e.g. the macerated fish input material is produced from frozen blocks and has a temperature of less than or equal to 10 °C), as described herein, the macerated fish input material is brought into contact with pre-heated water (e.g. pre-heated water bath) at a temperature of from about 60 °C to about 70 °C (e.g. from about 55 °C to about 70 °C, from about 65 °C to about 70 °C or from about 60 °C to about 75 °C) before the step of intrinsic enzymatic degradation. This way, the target temperature required for intrinsic enzymatic degradation to be performed is reached within a shorter period of time. In such embodiments, the step of intrinsic enzymatic degradation can then be performed within the pre-heated water once the target temperature has been reached. It will be understood that the pre-heated water will be suitable only to warm or thaw the macerated fish input material to the target temperature but without causing damage to the intrinsic enzymes required for intrinsic enzymatic degradation within the fish input material.

In embodiments, the step of maceration before undergoing the step of intrinsic enzymatic degradation provides a particle size within the fish input of from about 2 mm to about 6 mm, from about 3 mm to about 6 mm, from about 4 mm to about 6 mm, from about 5 mm to about 6 mm, from about 2 mm to about 5 mm, from about 2 mm to about 4 mm, from about 2 mm to about 3 mm, from about 1 mm to about 6 mm or from about 1 mm to about 3 mm. In some embodiments, the step of maceration before undergoing the step of intrinsic enzymatic degradation provides a particle size within the fish input of 6 mm or less, 5 mm or less, 4 mm or less, 3 mm or less, 2 mm or less, or 1 mm or less.

In embodiments, the hydrolysate intermediate is subjected to a first pasteurisation, optionally wherein the first pasteurisation is performed: (i) at a temperature of from about 60 °C to about 80 °C, and/or (ii) for a duration of from about 1 hour to about 12 hours. It will be appreciated that the hydrolysate intermediate will have undergone at least a step of intrinsic enzymatic degradation and optionally a step of proteolytic degradation in the presence of an additive proteolytic enzyme before being subjected to the first pasteurisation. As it will be understood, the hydrolysate intermediate is subjected to the first pasteurisation step to the extent that enzymes (e.g. intrinsic enzymes and or additive proteolytic enzyme material) present within the hydrolysate intermediate are denatured/destroyed and any bacterial strains present within the hydrolysate intermediate are killed. The hydrolysate intermediate may be agitated (e.g. circulated using a low shear open impeller pump) during the first pasteurisation step.

The first pasteurisation step may be performed at a temperature of from about 60 °C to about 80 °C, about 65 °C to about 80 °C, about 70 °C to about 80 °C, about 75 °C to about 80 °C, about 60 °C to about 75 °C, about 60 °C to about 70 °C or about 60 °C to about 65 °C.

In embodiments, the first pasteurisation step may be performed for a duration of from about 1 hour to about 12 hours, from about 1 hour to about 10 hours, from about 1 hour to about 8 hours, from about 1 hour to about 6 hours, from about 1 hour to about 4 hours, from about 2 hours to about 12 hours, from about 4 hours to about 12 hours, from about 6 hours to about 12 hours, from about 8 hours to about 12 hours or from about 10 hours to about 12 hours. The first pasteurisation step may be performed for a duration of approximately 3 hours.

A second pasteurisation may be performed after fermenting to produce the fish hydrolysate composition, optionally wherein the second pasteurisation is performed (i) at a temperature of from about 55 °C to about 75 °C and/or (ii) for a duration of from about 1 hour to about 4 hours. The fish hydrolysate composition may be agitated (e.g. circulated using a low shear open impeller pump) during the second pasteurisation step.

The second pasteurisation step may be performed at a temperature of from about 60 °C to about 80 °C, about 65 °C to about 80 °C, about 70 °C to about 80 °C, about 75 °C to about 80 °C, about 60 °C to about 75 °C, about 60 °C to about 70 °C or about 60 °C to about 65 °C.

In some embodiments, the fish hydrolysate composition is filtered after the second pasteurisation step. One such suitable filtering technique known to the skilled person involves filtering the fish hydrolysate composition through mesh screens containing suitable pore diameters in order to extract solid fish hydrolysate composition particles of certain sizes. The mesh screens may include pore diameters of from about 15 micron to about 500 micron depending on the end application. In such embodiments, the fish hydrolysate composition resides within the aqueous filtrate (liquid) which has been filtered. It will be appreciated that this step of optional filtering provides, in some embodiments, a final fish hydrolysate composition product which has improved aqueous solubility properties which is desirable for certain downstream applications (e.g. wherein the fish hydrolysate composition forms part of an aqueous fertiliser solution for sprinkler application).

Once filtered, in embodiments, the fish hydrolysate is evaporated to provide a solid. The solid may then be dried using any suitable drying technique, for example oven drying or freeze drying. The fish hydrolysate composition may undergo pelletisation.

Also disclosed herein is a fish hydrolysate composition obtained according to a method of the first aspect of the present invention or any embodiment thereof.

There is also provided an animal feed comprising the fish hydrolysate composition obtained according to a method of the first aspect of the present invention or any embodiment thereof or the fish hydrolysate composition according to the second aspect of the present invention or any embodiment thereof.

In embodiments, the animal feed comprises the fish hydrolysate composition in an amount of approximately 5 wt % (by weight of the animal feed in total) and, optionally, demonstrates a methane reduction (%) of from about 20% to about 30% as measured according suitable methods known to the skilled person (for example the method described herein under “Methane reduction tests”). It will be appreciated that the weight of the animal feed in total includes both the weight of the animal feed and fish hydrolysate composition when taken together.

In embodiments, the animal feed comprises the fish hydrolysate composition in an amount of approximately 10 wt % (by weight of the animal feed in total) and, optionally, demonstrates a methane reduction (%) of from about 25% to about 35% as measured according suitable methods known to the skilled person (for example the method described herein under “Methane reduction tests”).

In embodiments, the animal feed comprises the fish hydrolysate composition in an amount of approximately 20 wt % (by weight of the animal feed in total) and, optionally, demonstrates a methane reduction (%) of from about 70% to about 80% as measured according suitable methods known to the skilled person (for example the method described herein under “Methane reduction tests”).

In embodiments, the animal feed comprises the fish hydrolysate composition in an amount of approximately 30 wt % (by weight of the animal feed in total) and, optionally, demonstrates a methane reduction (%) of at least 95% as measured according suitable methods known to the skilled person (for example the method described herein under “Methane reduction tests”).

Disclosed herein is a fertiliser or soil enhancer comprising the fish hydrolysate composition obtained according to a method of the first aspect of the present invention or any embodiment thereof or the fish hydrolysate composition according to the second aspect of the present invention or any embodiment thereof.

Disclosed herein there is a method of reducing methane and/or increasing metabolic efficiency in an animal comprising administering the fish hydrolysate composition obtained according to a method of the first aspect of the present invention or any embodiment thereof or the fish hydrolysate composition according to the second aspect of the present invention or any embodiment thereof or animal feed according to the second aspect of the present invention or any embodiment thereof to an animal; optionally wherein the animal is a ruminant animal.

Also disclosed herein there is a composition for use in a method of reducing methane and/or increasing metabolic efficiency in an animal comprising administering the fish hydrolysate composition obtained according to a method of the first aspect of the present invention or any embodiment thereof or the fish hydrolysate composition according to the second aspect of the present invention or any embodiment thereof or animal feed according to the second aspect of the present invention or any embodiment thereof to an animal; optionally wherein the animal is a ruminant animal.

It will be appreciated that ruminant animal include, but are not limited by, the following animals cows, bulls, goats, sheep, giraffes, bison, moose, elk, yaks, water buffalo, deer, camels, alpacas, llamas and antelope.

### DESCRIPTION OF FIGURES

Embodiments of the present invention will now be described, by way of example only, with reference to the accompanying Figures in which:

FIG. 1 is a schematic showing a method of preparing a fish hydrolysate composition in accordance with the present invention.

FIG. 2 is a bar char illustrating the mean methane reduction (%) for fish hydrolysate composition A of the present invention at inclusion rates of 5%, 10%, 20% and 30%.

FIG. 3 is a bar char illustrating the mean methane reduction (%) for fish hydrolysate composition B of the present invention at inclusion rates of 5%, 10%, 20% and 30%.

### DETAILED DESCRIPTION OF THE INVENTION

The invention will be further described, by way of example only, with reference to the accompanying Figures.

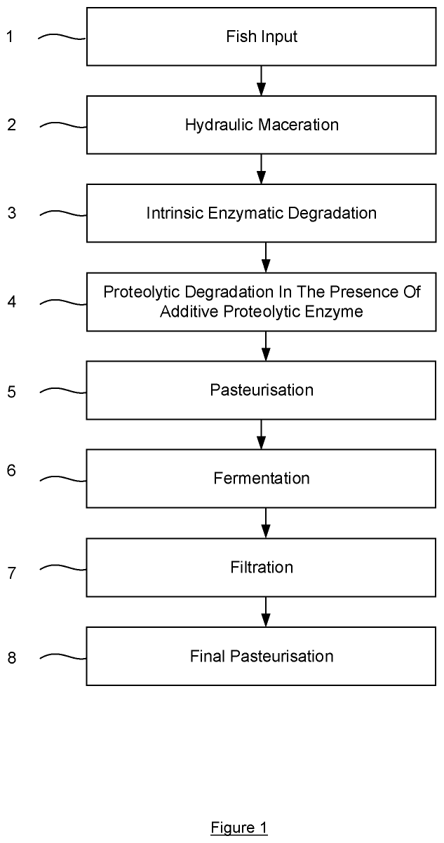

A method of preparing a fish hydrolysate composition in accordance with the present invention is provided in the schematic illustrated in FIG. 1. The exemplary method shown in FIG. 1 is described for frozen fish input (Blue Whiting (Micromesistius poutassou)) supplied by Ward Fish in 15 kilogram frozen blocks). Such frozen input may include, but without necessarily being limited to, whole fish, fish offal, fish bones, fish scales or any combination thereof. In accordance with the embodiment described with reference to FIG. 1, the fish input is provided in the form of frozen blocks weighing approximately 15 kilograms containing whole Blue Whiting fish.

During step (2) shown in FIG. 1, the frozen fish input is fed into a hydraulic macerator at a feed rate of 1 frozen block of fish input every 30 seconds. The fish input is macerated to produce a liquid or slurry medium containing water, fish meat and fish bone. The particle size of any solid matter in the liquid or slurry medium is controlled to a particle size of from about 2 mm to about 6 mm. This is done by selecting the perforation size of the screening die plate used within the hydraulic macerator. The liquid or slurry medium is extruded through the screening die plate directly into hopper which, in turns, transfers the fish medium into a pasteurisation tank.

Typically, the pasteurisation tank has a volume of approximately 5000 litres. The fish medium at this point is made up to ⅓ fish material and ⅔ water. The fish medium from the hopper mentioned above may be added to water located within the tank which is pre-heated to 60 °C-70 °C. The pre-heating of water may allow for the target temperature within the tank to be reached within a shorter period of time. The pasteurisation tank is fitted with a low shear open impeller pump which is used to ensure that the fish material in the tank is circulating. Circulation of material in the tank ensure that the fish based particulate matter and sediment in the tank are mobilised and prevents stratification of fish input material within the tank. As shown in FIG. 1 at step (3), the fish material is then held at approximately 40 °C under circulation for 2 hours. This, importantly, allows for intrinsic enzymatic degradation of the fish material to occur. No additive enzymes are added at this stage.

As illustrated at step (4), an additive proteolytic enzyme (Protease AP-30L from Enzyme Supplies, Liquid Preparation (10-12%), CAS No. 9001-92-7, Einecs-CE No 232-642-4, IUB Code 3.4.23.18) is added to the fish material within the tank in an amount of approximately 0.03 wt % by weight of the fish input. The material is then held at approximately 40 °C under circulation until a pH of 6 or less is achieved within the material. Typically a pH of 5.5 is achieved and can take approximately from about 1 hour to about 12 hours depending on the size of the batch.

The hydrolysate intermediate formed in step (4) is then pasteurised in step (5) at 65 °C to 75 °C for approximately 3 hours. This step ensures the enzymes present within the hydrolysate intermediate are denatured and any bacteria in the system is killed.

The hydrolysate intermediate is then transferred to a bio-refinery tank and cooled under circulation to a temperature of approximately 40 °C. Added to the cooled hydrolysate intermediate is molasses. Typically, the molasses is added in amount of approximately 30 wt % by weight of the fish input. As shown at step (6) in FIG. 1, bacterial strains Lactobacillus plantarum (1K20723), Pediococcus pentosaceus (1K2107) and Lactobacillus brevis (1K20723) are then added to the intermediate mixture before fermentation is performed. The fermentation process is performed for approximately 5 days to 10 days at approximately 30 °C-40 °C until a pH of 4 or less is achieved. This step utilises both homofermentative and heterofermentive bacterial strains whereby the strains work together. Lactobacillus plantarum and Pediococcus pentosaceus work to quickly lower the pH level of the fish medium by quickly producing lactic acid during the front-end primary fermentation cycle via rapid lactic acid production. This rapid pH drop helps control the fermentation step and inhibits anaerobic losses This is followed by a secondary fermentative cycle of lactic acid into acetic acid leading to a stabilised final product with a pH of 4 or less without the need to introduce additional acids.

At step (7) shown in FIG. 1, filtration of the fermented fish hydrolysate material is performed with screen decks of a certain size (e.g. from about 15 micron to about 500 micron depending on the end application).

A final pasteurisation step (8) is then performed on the filtered material at 65 °C to 75 °C for approximately 2 hours. The final fish hydrolysate product can then optionally be subjected to downstream processing. Evaporation or cryogenic evaporation separation can be utilised to provide solid material. Pelletisation and drying of this material can then be performed.

### Methane Reduction Tests

It will be appreciated that the following methane reduction tests are performed using an ANKOM RF Gas Production System (e.g. GEN 3 RF Gas Production System).

Exemplary fish hydrolysate compositions A and B were produced using the method illustrated in FIG. 1 and as described above. Exemplary fish hydrolysate composition A was however not subjected to the final pasteurisation step (8) whereas fish hydrolysate composition B was subjected to the final pasteurisation step (8).

Methane reduction tests were performed on fish hydrolysate compositions A and B according to the following protocol:
1. Rumen inoculum fluid from a ruminant animal (cow) was obtained.
2. Test samples were prepared in vials or agilent bottles using the following components:
   i. Feed substrate containing freeze-dried silage (typically 0.7 g).
   ii. Van Soest anaerobic incubation buffer added to pre-warmed vials at 39°—the amount added is dependent on the amount of fish hydrolysate composition included.
   iii. Rumen inoculum fluid (100 mL, strained through 2 layers of muslin and held under CO₂ at 39 °C)
   iv. Fish hydrolysate compositions—separate test samples were prepared in the absence of fish hydrolysate composition (control) and with fish hydrolysate compositions at inclusion rates of 5 wt % (by weight of the feed substrate and the fish hydrolysate composition in total), 10 wt % (by weight of the feed substrate and the fish hydrolysate composition in total), 20 wt % (by weight of the feed substrate and the fish hydrolysate composition in total) and 30 wt % (by weight of the feed substrate and the fish hydrolysate composition in total).
3. Vials/bottles were then sealed and incubated in an anaerobic incubator at 100 rpm (agitation) and 39 °C.
4. Methane measurement was performed in the head space of each sample at time points 0 hour, 4 hours, 24 hours and 48 hours using gas chromatography (GC).
5. Conversion of methane measurements to units of volume (mL) using the ideal gas law was performed or other conversion techniques known to the person skilled in the art.
6. Triplicate data was recorded for each sample.

Mean methane reduction measurements (e.g. mean across all time points) for fish hydrolysate compositions are shown in Table 1 and 2 below. The methane reduction (%) value is based on the reduced amount of methane as compared to the control sample.

TABLE 1
Mean methane reduction (%) for fish hydrolysate composition
A at inclusion rates of 5%, 10%, 20% and 30%

| Inclusion | Mean methane |
|---|---|
| rate % | reduction (%) |
| 5 | −4.56% |
| 10 | −29.09% |
| 20 | −64.24% |
| 30 | −88.09% |

TABLE 2
Mean methane reduction (%) for fish hydrolysate composition
B at inclusion rates of 5%, 10%, 20% and 30%

| Inclusion | Mean methane |
|---|---|
| rate % | reduction (%) |
| 5 | −20.7% |
| 10 | −26.2% |
| 20 | −75.3% |
| 30 | −95.7% |

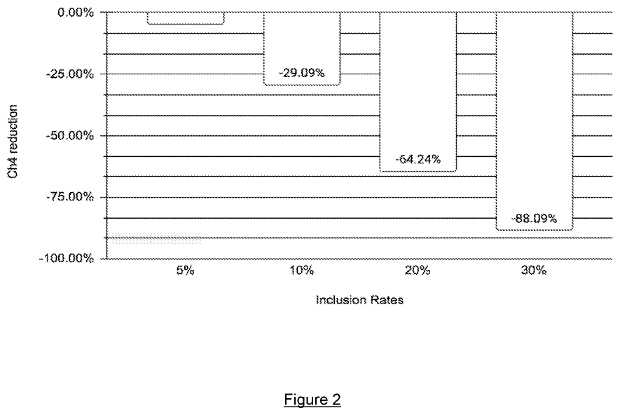

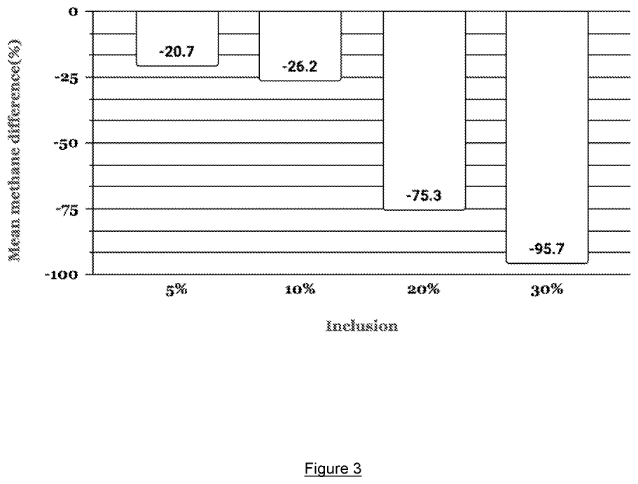

FIGS. 2 and 3 include bar charts illustrated the data presented in Tables 1 and 2, respectively.

As shown by the data presented in Tables 1 and 2 as well as FIGS. 2 and 3, when the inclusion rate of the fish hydrolysate compositions of the present invention within test sample feed substrates is increased, the methane reduction performance readout for the sample increases also. For both fish hydrolysate composition A and B, there is markedly improved methane reduction (%) as inclusions rates move from 5%, 10%, 20% through to 30%. Whilst fish hydrolysate composition A demonstrates an excellent methane reduction (%) profile at different inclusion rate profiles, fish hydrolysate composition B has unexpectedly been observed to deliver surprisingly improved methane reduction results at all of the inclusion rates. In particular, fish hydrolysate composition B is able to provide a methane reduction value of −20.7% even at the lower inclusion rate of 5% and −95.7% at an inclusion rate of 30%.

It will be appreciated that numerous modifications to the above described fish hydrolysate composition and a method of manufacturing the same may be made without departing from the spirit and scope of the invention, for instance, the scope of the invention as defined in the appended claims. Moreover, any one or more of the above aspects/embodiments could be combined with one or more feature of the other aspects/embodiments and all such combinations are intended with the present disclosure.

Optional and/or preferred features may be used in other combinations beyond those explicitly described herein and optional and/or preferred features described in relation to one aspect of the invention may also be present in another aspect of the invention, where appropriate.

The described and illustrated embodiments are to be considered as illustrative and not restrictive in character, it being understood that only the preferred embodiments have been shown and described and that all change and modifications that come within the scope of the invention as defined in the claims are desired to be protected. It should be understood that while the use of words such as “preferable”, “preferably”, “preferred”, or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a”. “an” or “at least one” are used to preface a feature there is no intention to limit the claim to only one such feature unless specifically stated to the contrary in the claims.

1. A method of preparing a fish hydrolysate composition, comprising:
providing a fish input;
performing a step of intrinsic enzymatic degradation, in the absence of an additive enzyme, to provide a hydrolysate intermediate; and
fermenting the hydrolysate intermediate in the presence of a lactic acid producing bacterial culture media to produce the fish hydrolysate composition.

2. A method according to claim 1, wherein the step of intrinsic enzymatic degradation is performed at a temperature of from about 30 °C to about 50 °C; optionally wherein the step of intrinsic enzymatic degradation is performed for a duration of from about 0.5 hours to about 5 hours.

3. A method according to claim 1, wherein the step of intrinsic enzymatic degradation comprises degradation by at least one intrinsic enzyme comprising a proteolytic enzyme, carbohydrase enzyme, lipolytic enzyme, phosphatase enzyme or any combination thereof.

4. A method according to claim 3, wherein:
(a) the proteolytic enzyme is selected from the group consisting of a trypsin, carboxypeptidase A and carboxypeptidase B or any combination thereof; and/or
(b) the carbohydrase enzyme is selected from the group consisting of a maltase, amylase or any combination thereof; and/or
(c) the lipolytic enzyme is a lipase; and/or
(d) the phosphatase enzyme is an alkaline phosphatase.

5. A method according to claim 1, wherein the step of intrinsic enzymatic degradation is followed by the addition of an additive proteolytic enzyme and then proteolytic degradation until a pH of 6 or less is reached to provide a hydrolysate intermediate.

6. A method according to claim 5, wherein the additive proteolytic enzyme is added in an amount of from about 0.01 wt % (by weight of the fish input) to about 1 wt % (by weight of the fish input).

7. A method according to claim 1, wherein the lactic acid producing bacterial culture media comprises at least one species from the Lactobacillus genus and optionally a sugar component.

8. A method according to claim 7, wherein:
(a) the bacterial culture media comprises a Lactobacillus plantarum, Pediococcus pentosaceus and Lactobacillus brevis; and/or
(b) the sugar component comprises molasses; and/or
(c) the sugar component is used in an amount of from about 25 wt % (by weight of the fish input) to about 50 wt % (by weight of the fish input).

9. A method according to claim 1, wherein fermenting the hydrolysate intermediate in the presence of a lactic acid producing bacterial culture media to produce the fish hydrolysate composition is performed at a temperature of from about 30 °C to about 50 °C; optionally wherein fermenting the hydrolysate intermediate in the presence of a lactic acid producing bacterial culture media to produce the fish hydrolysate composition is performed for a duration of from about 120 hours to about 240 hours.

10. A method according to claim 1, wherein fermenting the hydrolysate intermediate in the presence of a lactic acid producing bacterial culture media to produce the fish hydrolysate composition is performed until a pH of 4 or less is reached.

11. A method according to claim 1, wherein the fish input undergoes a step of maceration before undergoing the step of intrinsic enzymatic degradation; optionally wherein the step of maceration provides a particle size within the fish input of from about 2 mm to about 6 mm.

12. A method according to claim 1, wherein the hydrolysate intermediate is subjected to a first pasteurisation, optionally wherein the first pasteurisation is performed:
(i) at a temperature of from about 60 °C to about 80 °C; and/or
(ii) for a duration of from about 1 hour to about 12 hours.

13. A method according to claim 1, wherein a second pasteurisation is performed after the step of fermenting to produce the fish hydrolysate composition, optionally wherein the second pasteurisation is performed:
(i) at a temperature of from about 55 °C to about 75 °C; and/or
(ii) for a duration of from about 1 hour to about 4 hours.

14. A fish hydrolysate composition obtained according to a method of claim 1.

15. An animal feed comprising the fish hydrolysate composition obtained according to a method of claim 1.

16. A fertiliser or soil enhancer comprising the fish hydrolysate composition obtained according to a method of claim 1.

17. A method of reducing methane and/or increasing metabolic efficiency in an animal comprising administering the animal feed according to claim 15 to an animal; optionally wherein the animal is a ruminant animal.

18. A composition for use in a method of reducing methane and/or increasing metabolic efficiency comprising administering the animal feed according to claim 15 to an animal; optionally wherein the animal is a ruminant animal.

19. Use of the fish fertiliser or soil enhancer according to claim 16 for horticulture or agriculture.
